(19) United States
(12) Patent Application Publication
(10) Pub. No.: US 2022/0140556 A1
(43) Pub. Date: May 5, 2022

(54) SEALING MECHANISM INSIDE ELECTRICAL MEMBER

(71) Applicant: YOKOWO CO., LTD., Kita-Ku, Tokyo (JP)

(72) Inventor: Nozomu MORITA, Kita-Ku, Tokyo (JP)

(73) Assignee: YOKOWO CO., LTD., Kita-ku, Tokyo (JP)

(21) Appl. No.: 17/432,107

(22) PCT Filed: Nov. 19, 2019
(86) PCT No.: PCT/JP2019/045175

§ 371 Date: Aug. 19, 2021

(30) Foreign Application Priority Data
Feb. 20, 2019 (JP) 2019-028134

(51) Int. Cl. H01R 33/965; H01R 13/52; H01R 13/11; H01R 33/05

(52) U.S. Cl. CPC H01R 33/965; H01R 13/5205; F21V 23/06; H01R 33/05; H01R 13/11

(57) ABSTRACT

A sealing mechanism is disposed inside an electrical member capable of securing waterproofness with a simple structure. The cable sealing mechanism of the electrical member includes a gasket having cable through-gasket-holes through which a cable passes, and being made of an elastic body, sockets (first socket, second socket) of an electronic component (light emitting element) that operate by supplying power via the cable, a cover that covers the electronic component, the sockets, and the gasket, and a bracket that sandwiches the electronic component, the sockets, and the gasket together with the cover. The gasket is disposed between the sockets and the bracket. By attaching the cover to the bracket, the gasket comes into close contact with an inner wall of the cover, the cable through-gasket-holes come into close contact with the covering portion of the cable, and a space between the cover and the gasket is sealed.

### TECHNICAL FIELD

The present invention relates to a sealing mechanism inside an electrical member.

### BACKGROUND ART

Conventionally, a light emitting device such as an LED has been proposed as in Patent Literature 1.

### CITATION LIST

### Patent Literature

Patent Literature 1: JP 2015-95401 A

### SUMMARY OF INVENTION

### Technical Problem

In such an electrical member such as a light emitting device, waterproofing of a portion in contact with a cable and waterproofing of a portion other than the portion in contact with the cable are separately performed using an O-ring or a sealant, and thus a structure is complicated.

Therefore, an object of the present invention is to provide a sealing mechanism inside an electrical member, capable of securing waterproofness with a simple structure.

### Solution to Problem

A sealing mechanism inside an electrical member according to the present invention includes: a gasket having cable through-gasket-holes through which a cable passes, and being made of an elastic body; a socket of an electronic component that operates by supplying power via the cable; a cover that covers the electronic component, the socket, and the gasket; and a bracket that sandwiches the electronic component, the socket, and the gasket together with the cover. The gasket is disposed between the socket and the bracket. By attaching the cover to the bracket, the gasket is pressed in a direction in which the cover is attached, and is deformed. For example, the gasket is pressed in the attaching direction, a diameter of the gasket increases, and a diameter of the cable through-gasket-hole decreases. Preferably, by attaching the cover to the bracket, the gasket comes into close contact with an inner wall of the cover, the cable through-gasket-hole comes into close contact with a covering portion of the cable, and a space between the cover and the gasket is sealed.

By the deformation of the gasket, it is possible to realize waterproofing of the space surrounded by the cover and the gasket and holding of the cable. In addition, as compared with a form of waterproofing or holding a cable using a plurality of O-rings or sealants, a structure can be simplified, and attachment and detachment can be facilitated.

Preferably, the sealing mechanism inside the electrical member further includes a pressing portion. The socket has a connector. The connector includes a leaf spring portion that clamps a terminal of the electronic component, and a pressure receiving portion that contacts with a conductor portion of the cable. The pressing portion presses the conductor portion in a direction in which the pressure receiving portion is located. By attaching the cover to the bracket, pressing by the pressing portion is performed. For example, the pressing portion presses the conductor portion from a direction different from a direction in which the cover is attached, so that pressing is performed by the pressing portion, and the conductor portion is crushed between the pressing portion and the pressure receiving portion.

By clamping of the leaf spring, the electronic component such as a light emitting element can be easily attached to the socket.

In addition, at a time of attaching of the cover 10 and the bracket 80 which deform the gasket 70, a cable connection using the pressing portions 60 can be simultaneously performed.

More preferably, the socket has a pressing portion through-hole into which the pressing portion is inserted.

The pressing receiving portion can be visually recognized through the pressing portion through-hole. Therefore, it is possible to confirm whether the cable is correctly inserted through the pressing portion through-hole.

More preferably, the pressing portion through-hole holds the pressing portion when the pressing by the pressing portion is released.

As a result, it is possible to reduce a possibility that the pressing portion is detached and lost when the pressing by the pressing portion is released.

Preferably, the socket has a cable through-socket-hole through which the cable passes. A stepped portion is formed between a contact surface of the pressure receiving portion with which the conductor portion is in contact and a contact surface of the cable through-socket-hole with which the conductor portion is in contact.

Due to this stepped portion, the conductor portion can be bent into an S-shape or a crank-shape at a time of pressing. Therefore, a connection state between the pressure receiving portion and the conductor portion can be further strengthened as compared with a form in which the bending is not performed.

Preferably, the cover is attached to the bracket by hooking.

Preferably, the socket includes a first socket in contact with the electronic component and a second socket in contact with the gasket.

More preferably, one of the cover and the bracket has a first hooking portion. The cover is attached to the bracket by the first hooking portion in a state where the first socket, the second socket, and the gasket are sandwiched by the cover and the bracket. One of the first socket and the bracket has a second hooking portion. The first socket is attached to the bracket by the second hooking portion in a state where the second socket and the gasket are sandwiched between the cover and the bracket.

Preferably, the socket has a cable through-socket-hole through which the cable passes. The cable through-socket-hole has an inclined region whose inner diameter decreases from a side where the cable is inserted.

### Advantageous Effects of Invention

As described above, according to the present invention, it is possible to provide a sealing mechanism inside an electrical member capable of securing waterproofness with a simple structure.

### BRIEF DESCRIPTION OF DRAWINGS

FIG. 1 is a perspective view as viewed from an upper front side, of an electrical member according to the present embodiment, in which a cover is illustrated in cross section, and upper halves of a first socket, a second socket, and a bracket are illustrated in cross section.

FIG. 2 is a side view as viewed from the x- direction, of the electrical member of the present embodiment, illustrating an upper half of the cover in cross section.

FIG. 3 is a perspective view as viewed from an upper front side, illustrating a state in which the cover and a fourth assembly are separated from each other.

FIG. 4 is a perspective view of the fourth assembly as viewed from an upper front side, illustrating upper halves of a first socket, a second socket, and a bracket in cross section.

FIG. 5 is a top view of a third assembly as viewed from a z-direction.

FIG. 6 is a cross-sectional configuration view illustrating the second socket in which a connector is attached to one of second connector storage holes and a pressing portion is attached to one of pressing portion through-holes.

FIG. 7 is a perspective view as viewed from an upper front side, illustrating a state in which the third assembly and the pressing portion are separated from each other.

FIG. 8 is a perspective view as viewed from an upper back side, illustrating a state in which a second assembly and a cable are separated from each other.

FIG. 9 is a perspective view as viewed from an upper front side, illustrating a state in which a first assembly and a light emitting element are separated from each other.

FIG. 10 is a perspective view of the first assembly as viewed from an upper front side.

FIG. 11 is a perspective view as viewed from an upper front side, of an assembly in which the pressing portion is attached to the first assembly, illustrating an upper half of the assembly in cross section.

FIG. 12 is a side view as viewed from the x-direction, of an assembly in which the pressing portion is attached to the first assembly, illustrating an upper half of the assembly in cross section.

FIG. 13 is a top view as viewed from the z-direction, of an assembly in which the pressing portion is attached to the first assembly, illustrating a right half of the assembly in cross section.

FIG. 14 is a side view of the first assembly as viewed from the x-direction.

FIG. 15 is a perspective view as viewed from a lower front side, illustrating a state in which a socket and a bracket assembly are separated from each other.

FIG. 16 is a perspective view as viewed from a lower front side, illustrating a state in which the first socket, the second socket, and the connector are separated from each other.

FIG. 17 is a perspective view as viewed from an upper back side, illustrating a state in which the first socket, the second socket, and the connector are separated from each other.

FIG. 18 is a perspective view as viewed from a lower front side, illustrating a state in which a gasket and the bracket are separated from each other.

FIG. 19 is a perspective view of the connector as viewed from a lower back side.

FIG. 20 is a front view of the gasket as viewed from the y-direction.

FIG. 21 is a perspective view as viewed from a lower back side, illustrating a state in which the connector is attached to the light emitting element without the socket interposed therebetween.

### DESCRIPTION OF EMBODIMENTS

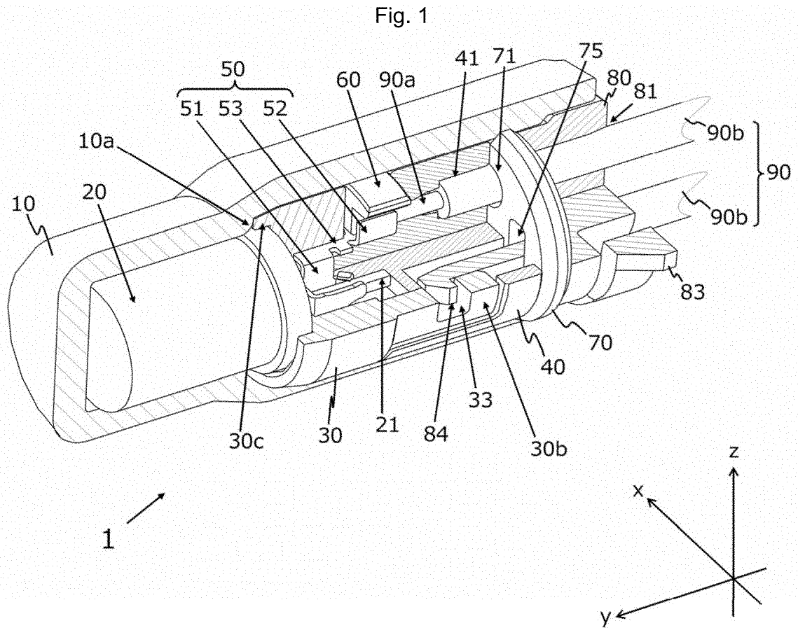

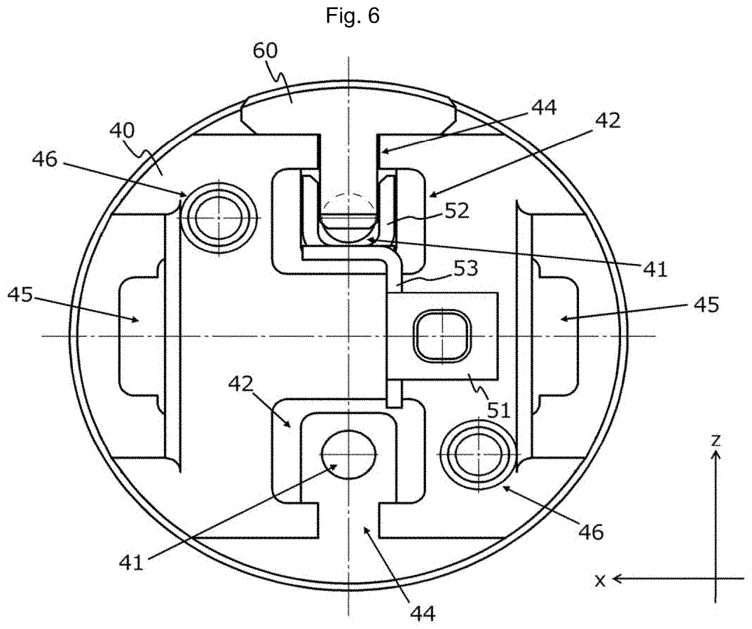

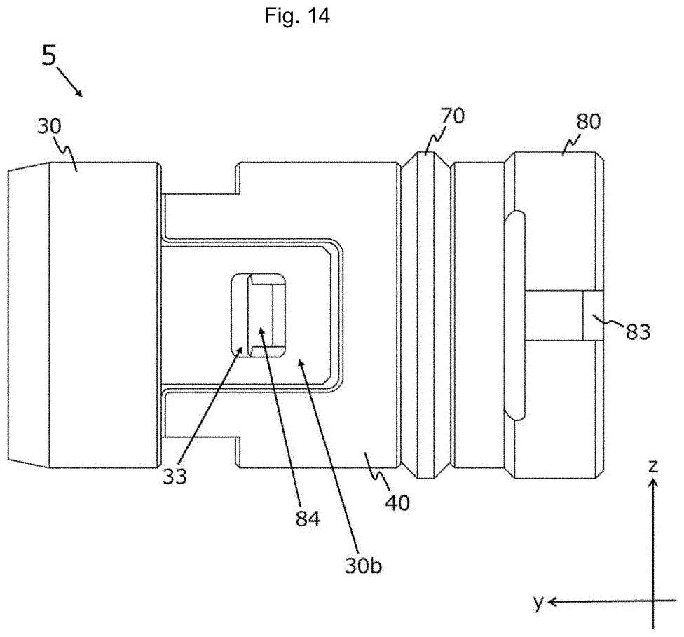

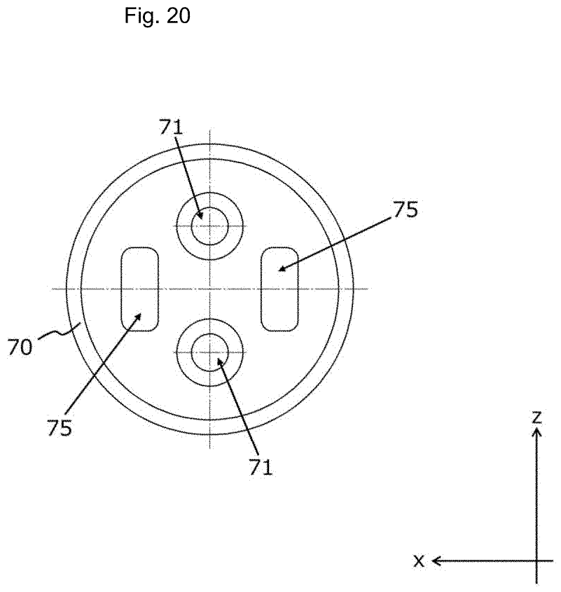

Hereinafter, the present embodiment will be described with reference to FIGS. 1 to 21.

Note that the embodiment is not limited to the following embodiment. In addition, the contents described in one embodiment are similarly applied to other embodiments in principle. Further, each embodiment and each modification can be appropriately combined.

As shown in FIGS. 1 to 3 and FIGS. 16 to 17, an electrical member 1 of the present embodiment includes a cover 10, a light emitting element 20, a first socket 30, a second socket 40, connectors 50, pressing portions 60, a gasket 70, a bracket 80, and cables 90.

In the electrical member 1, the cover 10, the first socket 30, the second socket 40, the gasket 70, and the bracket 80 constitute a sealing mechanism inside the electrical member 1 including a portion of the cables 90 and the like.

In order to make a description easy to understand, a socket 2 is defined as being formed by assembling the first socket 30, the second socket 40, and the connectors 50.

An assembly in which the gasket 70 and the bracket 80 have been assembled is referred to as a bracket assembly 3.

In addition, an assembly in which the socket 2 and the bracket assembly 3 have been assembled is referred to as a first assembly 5.

In addition, an assembly in which the light emitting element 20 has been attached to the first assembly is referred to as a second assembly 6.

In addition, an assembly in which the cables 90 have been inserted into the second assembly 6 is referred to as a third assembly 7.

In addition, an assembly in which the pressing portion 60 has been attached to the third assembly 7 is referred to as a fourth assembly 8.

In order to describe directions, a horizontal direction (left-right direction) perpendicular to a direction in which the cables 90 are inserted into the second assembly 6 is defined as an x-direction, a direction (front-rear direction) in which the cables 90 are inserted into the second assembly 6 is defined as a y-direction, and a direction (up-down direction) perpendicular to the x-direction and the y-direction is defined as a z-direction.

In FIG. 1, directions indicated by arrows of xyz-axes are defined as a left direction, a front direction, and an upper direction, respectively.

(Description of cover 10) Next, details of the cover 10 will be described. The cover 10 has a tubular shape that is opened only on a bracket 80 side.

The bracket 80 side of the cover 10 has first hooking holes 13.

The first hooking hole 13 is used for hooking a first hooking portion 83 of the bracket 80.

The first hooking hole 13 is a hole penetrating in the x-direction.

The first hooking hole 13 is provided on a cylindrical wall surface constituting the cover 10.

The cover 10 and the bracket 80 accommodate the light emitting element 20, the first socket 30, the second socket 40, the connectors 50, the pressing portions 60, and the gasket 70.

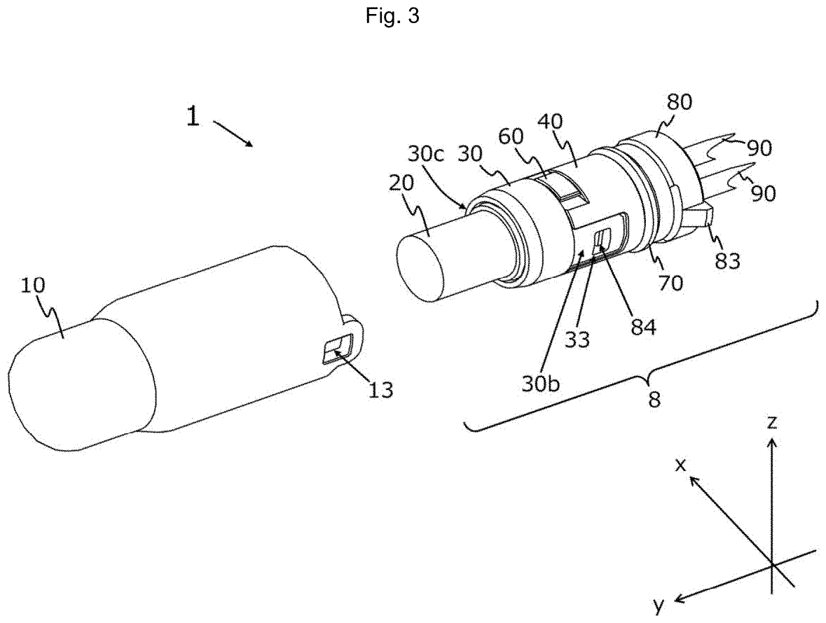

An inner wall of the cover 10 has substantially a same shape as an outer shape of a portion of the fourth assembly 8 (see FIG. 3) except for a rear side of the bracket 80 in the y-direction. The fourth assembly 8 is an assembly in which the light emitting element 20, the first socket 30, the second socket 40, the connectors 50, the pressing portions 60, the gasket 70, and the bracket 80 are assembled.

A boundary portion between a region covering the light emitting element 20 and a region covering the first socket 30, on the inner wall of the cover 10, has a holding portion 10a. The holding portion 10a holds a peripheral edge portion 30c on a front side of the first socket 30 in the y-direction.

In the present embodiment, a stepped portion formed on said boundary portion functions as the holding portion 10a. However, the holding portion 10a is not limited to such stepped portion, and may be formed in another shape such as a protrusion.

In addition, a dimension of the inner wall of the cover 10 is determined such that a gap (first clearance c1) is provided between a region of the inner wall of the cover 10, covering the light emitting element 20, and the light emitting element 20.

This first clearance c1 enables the cover 10 to accommodate the light emitting element 20 or the like even when an actual size of the light emitting element 20 is slightly different from a predetermined size.

When the first hooking portion 83 of the bracket 80 is hooked to the first hooking hole 13 of the cover 10, the inner wall of the cover 10 covers a front surface and a side surface of the light emitting element 20, a side surface of the first socket 30, a side surface of the second socket 40, a side surface of the gasket 70, and a side surface of the bracket 80.

The holding portion 10a of the cover 10 and the bracket 80 sandwich the first socket 30, the second socket 40, and the gasket 70 in the y-direction, and press the gasket 70 in the y-direction.

As a result, it enables a sealing or the like of a space surrounded by the cover 10 and the gasket 70.

The holding portion 10a of the cover 10 and the bracket 80 sandwich the socket 2 and the gasket 70. Therefore, the light emitting element 20 does not have to receive the pressure sandwiched between the cover 10 and the bracket 80 in the y-direction.

The detail of the sealing or the like of the space surrounded by the cover 10 and the gasket 70 will be described later.

The cover 10 is made of a resin material containing transparent or translucent acryl, polycarbonate (PC), ABS (acrylonitrile butadiene styrene, copolymer synthetic resin), or the like.

(Description of Light Emitting Element 20)

Next, details of the light emitting element 20 will be described.

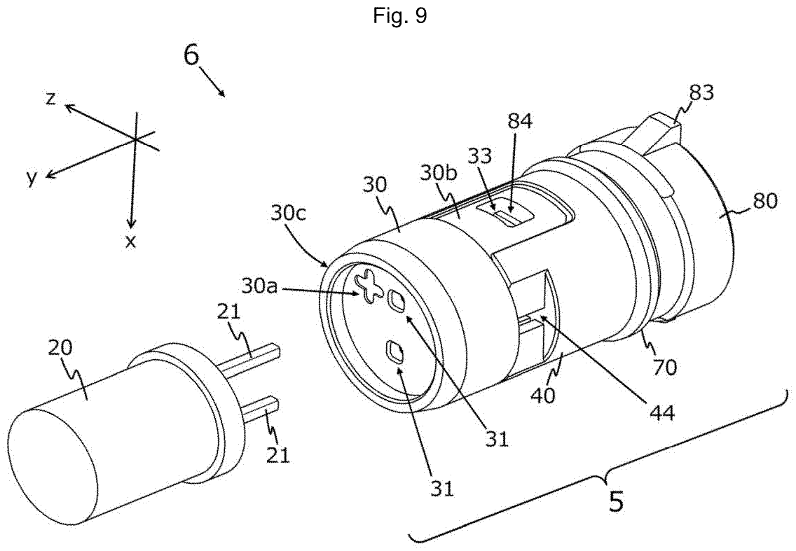

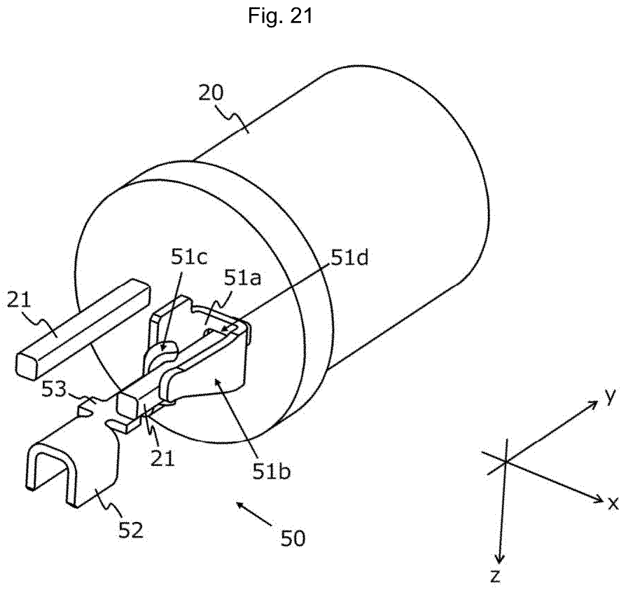

The light emitting element 20 is a light emitting member such as an LED. As illustrated in FIGS. 9 and 21, two terminals 21 extend rearward in the y-direction, from a rear side of the light emitting element 20 in the y-direction.

One terminal 21 is connected to one cable 90 via one connector 50 and functions as an anode.

The other terminal 21 is connected to the other cable 90 via the other connector 50 and functions as a cathode.

The light emitting element 20 operates on the basis of power supplied via the cable 90.

(Description of First Socket 30)

Next, details of the first socket 30 will be described.

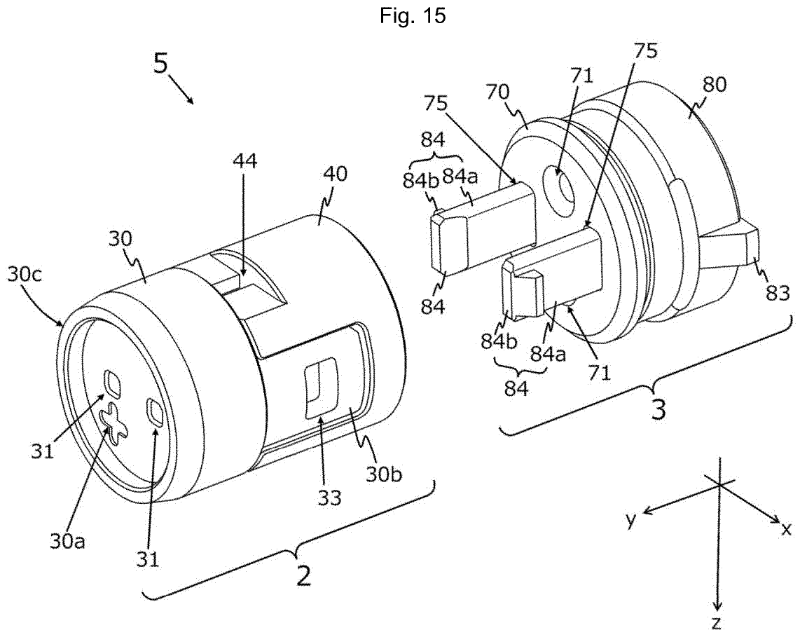

As illustrated in FIGS. 15 to 17, the first socket 30 includes terminal holes 31, first connector storage holes 32, second hooking holes 33, and fitting recesses 36. The first socket 30 has a substantially cylindrical shape.

The light emitting element 20 is attached to the front side of the first socket 30 in the y-direction.

The front side of the first socket 30 in the y-direction has a recessed shape in which the peripheral edge portion 30c is raised. The light emitting element 20 is fitted into the recessed portion of the first socket 30.

Here, two terminal holes 31 and two first connector storage holes 32 are provided for the anode and the cathode.

The terminal holes 31 penetrate a body of the substantially cylindrical first socket 30 in the y-direction. The terminal hole 31 is a hole into which the terminal 21 of the light emitting element 20 is inserted.

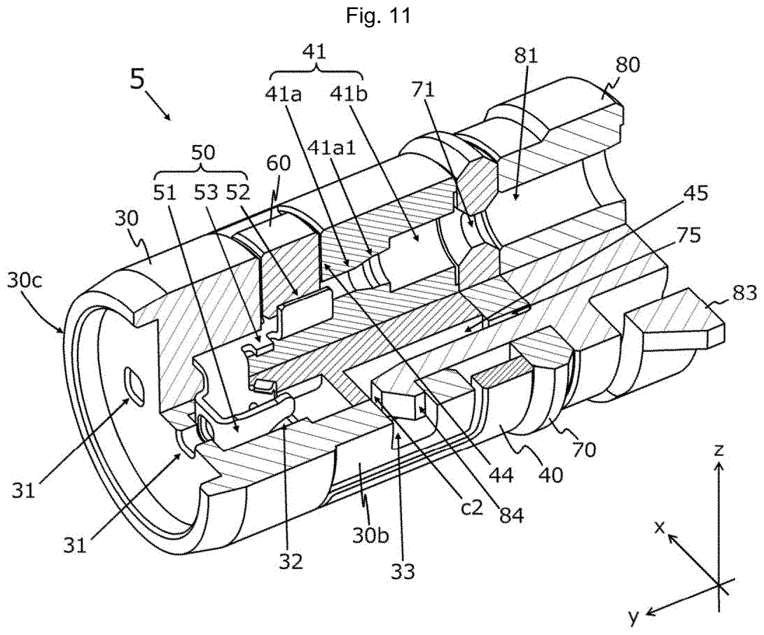

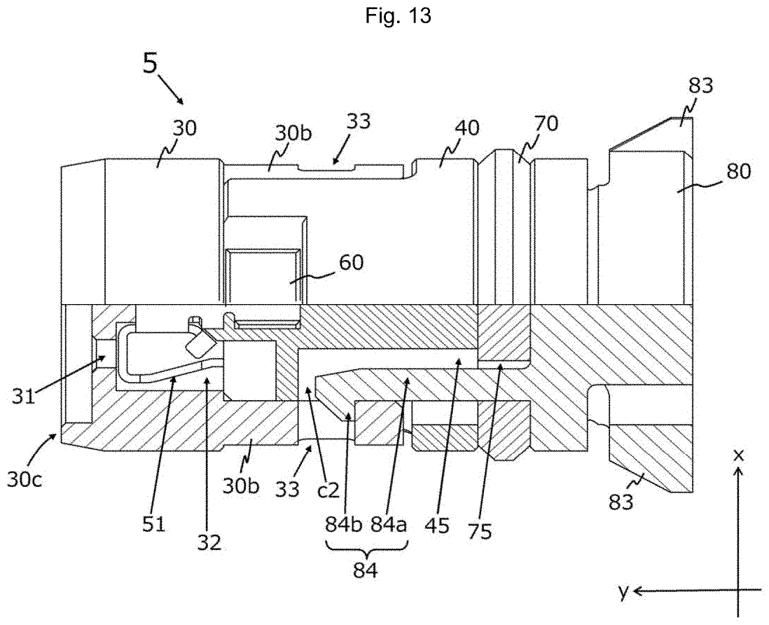

The first connector storage hole 32 communicates with the terminal hole 31. The first connector storage hole 32 is used as a recess that holds a terminal receiving portion 51 of the connector 50 (see FIGS. 11 and 13).

Therefore, the first connector storage hole 32 located on a rear side in the y-direction has a larger xz-cross section of the hole than that of the terminal hole 31 located on a front side in the y-direction.

A front side of the first socket 30 in the y-direction desirably has a first mark 30a so as not to mistake between an insertion of the one terminal 21 (anode) into the one terminal hole 31 and an insertion of the other terminal 21 (cathode) into the other terminal hole 31 (see FIGS. 9, 10, 15, and 16).

The present embodiment shows an example in which the cross-shaped first mark 30a is provided near one terminal hole 31 on the front side of first socket 30 in the y-direction.

However, the first mark 30a is not limited to the mark illustrated in FIG. 9, and may be a mark having another shape.

The first socket 30 has mounting pieces 30b. The mounting pieces 30b extend rearward in the y-direction from the main body of the substantially cylindrical first socket 30.

Here, two mounting pieces 30b are provided on a rear side of the first socket 30 in the y-direction, and face each other in the x-direction.

However, the direction in which the two mounting pieces 30b face each other is not limited to the x-direction, and may be another direction perpendicular to the y-direction, such as the z-direction.

The mounting pieces 30b are formed integrally with the main body of the first socket 30.

Each of the two mounting pieces 30b has the second hooking hole 33 penetrating in the x-direction.

The second hooking holes 33 provided in the respective mounting pieces 30b have a positional relationship of facing each other in the x-direction.

The second hooking portion 84 of the bracket 80 is hooked to the second hooking hole 33.

When the second hooking portions 84 of the bracket 80 are hooked to the second hooking holes 33 of the first socket 30, the second socket 40 and the gasket 70 are positioned between the first socket 30 and the bracket 80.

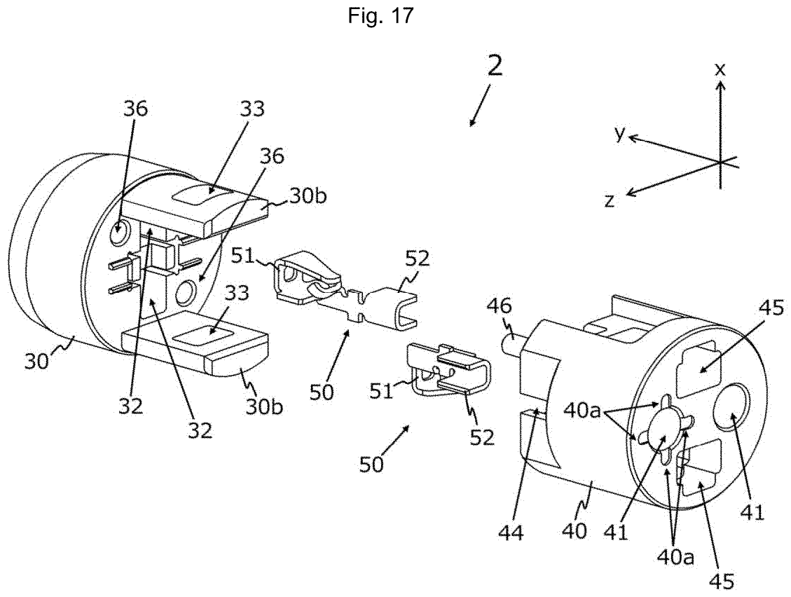

The fitting recesses 36 are provided on a side (rear side in the y-direction) of the first socket 30 facing the second socket 40 (see FIG. 17). The fitting recesses 36 extend forward in the y-direction, from the rear side of the first socket 30 in the y-direction.

The fitting recess 36 is fitted with a fitting protrusion 46 of the second socket 40.

(Description of Second Socket 40)

Next, details of the second socket 40 will be described.

As illustrated in FIGS. 15 to 17, the second socket 40 has cable through-socket-holes 41, second connector storage holes 42, pressing portion through-holes 44, claw through-socket-holes 45, and the fitting protrusions 46. The second socket 40 has a substantially cylindrical shape.

Specifically, two cable through-socket-holes 41 and two second connector storage holes 42 are provided for the anode and the cathode, respectively.

The cable through-socket-hole 41 penetrates the main body of the substantially cylindrical second socket 40 in the y-direction. The cable through-socket-hole 41 is a hole for inserting the cable 90.

In the second connector storage hole 42 and in a conductor-portion holding region 41a on a front side in the y-direction of the cable through-socket-hole 41, a conductor portion 90a of the cable 90 is disposed (see FIG. 11). In a covering-portion holding region 41b on a rear side of the cable through-socket-hole 41 in the y-direction, a covering portion 90b of the cable 90 is disposed.

Therefore, as illustrated in FIGS. 11 to 13, a diameter of the conductor-portion holding region 41a on the front side in the y-direction of the cable through-socket-hole 41 is smaller than a diameter of the covering-portion holding region 41b on the rear side in the y-direction of the cable through-socket-hole 41.

The second connector storage hole 42 communicates with the cable through-socket-hole 41. The second connector storage hole 42 is used as a recess that holds a cable receiving portion 52 of the connector 50.

Therefore, the second connector storage hole 42 located on a front side in the y-direction has a larger xz-cross section of the hole than that of the front side in the y-direction (conductor-portion holding region 41a) of the cable through-socket-holes 41 located on the rear side in the y-direction.

A side of the conductor-portion holding region 41a, in contact with the covering-portion holding region 41b has an inclined region 41a1. In an inclined region 41a1, an inner diameter of the conductor-portion holding region 41a gradually decreases from a side where the cable 90 is inserted (rear side in the y-direction) toward a deeper side in the insertion direction (front side in the y-direction).

Since the conductor portion 90a passes through the inclined region 41a1, a tip of the conductor portion 90a can be integrated in a region having a constant diameter. As a result, it is possible to suppress a portion or the whole of the conductor portion 90a from being caught in the middle of the cable through-socket-hole 41, and it is possible to realize secured and highly reliable wiring of the conductor portion 90a.

A rear side of the second socket 40 in the y-direction desirably has a second mark 40a so as not to mistake between an insertion of one cable 90 into one cable through-socket-hole 41 and an insertion of the other cable 90 into the other cable through-socket-hole 41 (see FIG. 17).

The present embodiment shows an example in which four grain-shaped second marks 40a are provided around one of the cable through-socket-holes 41 on the rear side of the second socket 40 in the y-direction.

However, the second mark 40a is not limited to the mark illustrated in FIG. 17, and may be a mark having another shape.

The pressing portion through-holes 44 are provided at two locations on side surfaces of the second socket 40.

One of the pressing portion through-holes 44 is provided on an upper side of the side surface of the second socket 40 in the z-direction and communicates with one of the second connector storage holes 42.

The other pressing portion through-hole 44 is provided on a lower side of the side surface of the second socket 40 in the z-direction and communicates with the other second connector storage hole 42.

When the cable 90 is inserted into the second assembly 6, the pressing portion through-hole 44 faces the tip of the conductor portion 90a in the z-direction.

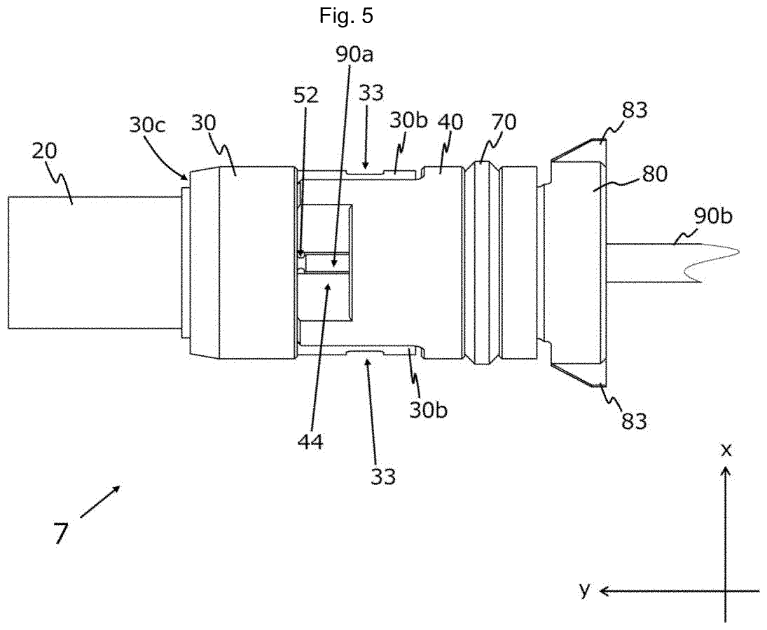

Therefore, in a state of the third assembly 7, a tip of one conductor portion 90a can be seen from the upper side in the z-direction through one pressing portion through-hole 44, and a tip of the other conductor portion 90a can be seen from the lower side in the z-direction through the other pressing portion through-hole 44 (see FIG. 5).

However, the direction in which the two pressing portion through-holes 44 face each other is not limited to the z-direction, and may be another direction perpendicular to the y-direction such as the x-direction.

Here, two claw through-socket-holes 45 are provided.

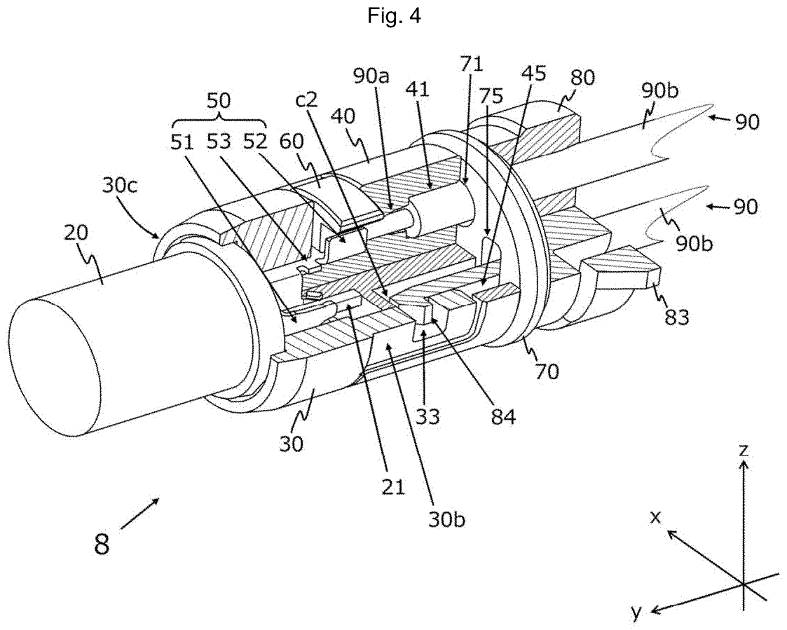

As illustrated in FIGS. 4, 11, and 13, the claw through-socket-hole 45 penetrates the main body of the substantially cylindrical second socket 40 in the y-direction. The claw through-socket-holes 45 is a hole for inserting the second hooking portion 84.

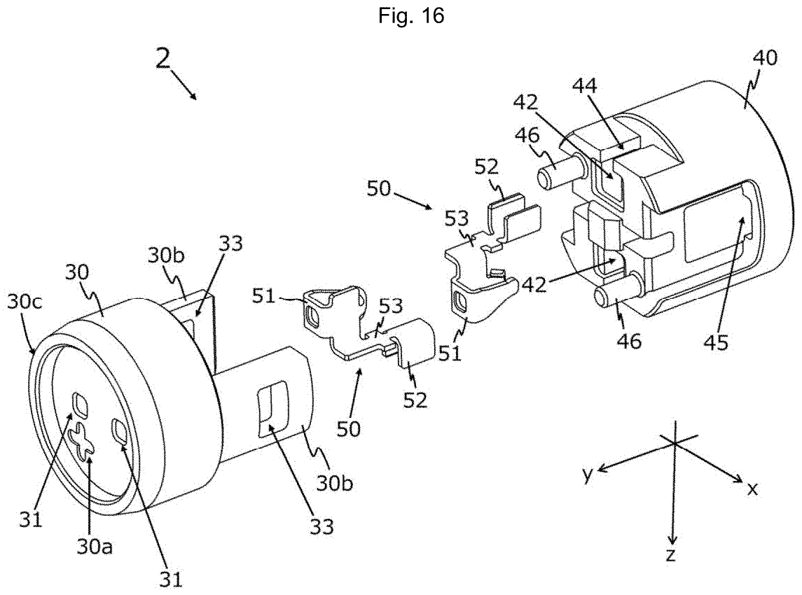

As shown in FIG. 16 and FIG. 17, the fitting protrusion 46 is a protrusion protruding to a front side in the y-direction from the main body of the substantially cylindrical second socket 40. The fitting protrusion 46 is fitted into the fitting recess 36 of the first socket 30.

The fitting protrusion 46 is used for aligning the first socket 30 and the second socket 40.

(Description of Connector 50)

Next, the connector 50 will be described in detail.

Two connectors 50 are provided for the anode and the cathode.

As illustrated in FIGS. 4, 6, 12, 13, 16, 17, 19, and 21, the connector 50 includes the terminal receiving portion 51, the cable receiving portion 52, and a connector connecting portion 53.

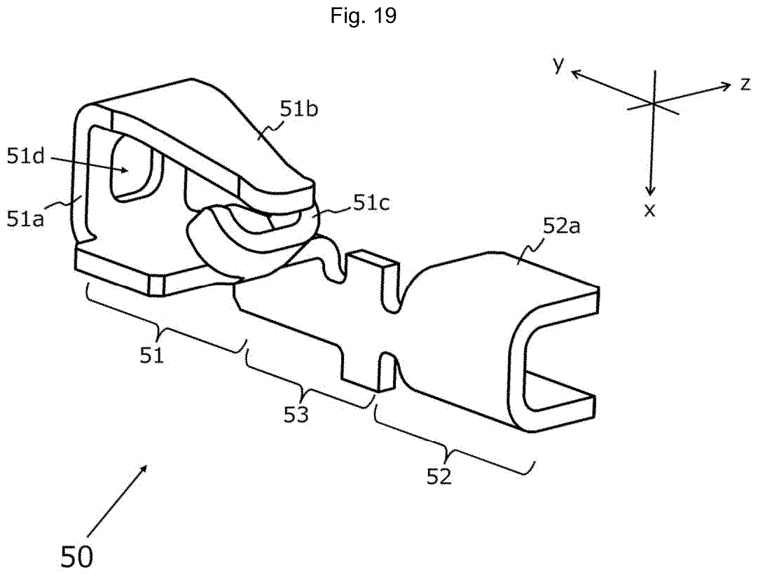

The terminal receiving portion 51 includes a terminal insertion portion 51a, a leaf spring portion 51b, and an edge 51c (see FIG. 19).

The terminal insertion portion 51a has a hole (terminal insertion hole 51d) into which the terminal 21 is inserted. The leaf spring portion 51b and edge 51c extend rearward in the y-direction from the terminal insertion portion 51a.

The leaf spring portion 51b is biased in a direction approaching the edge 51c.

The edge 51c has a substantially U-shaped cross section in which the leaf spring portion 51b side is opened.

The terminal 21 of the light emitting element 20 is inserted into the terminal insertion hole 51d of the terminal insertion portion 51a, and a tip of the terminal 21 is clamped between the leaf spring portion 51b and the edge 51c.

Accordingly, the terminal 21 is attached to the terminal receiving portion 51.

Since the edge 51c has the substantially U-shaped cross section, the edge 51c and the leaf spring portion 51b surround the terminal 21. Therefore, the terminal 21 is less likely to fall off, and the clamping of the terminal 21 by the edge 51c and the leaf spring portion 51b is easily maintained.

The cable receiving portion 52 has a pressure receiving portion 52a. The pressure receiving portion 52a has a substantially U-shaped cross section in which a side facing the pressing portion 60 in the z-direction is opened.

In the pressure receiving portion 52a, the tip of the conductor portion 90a is disposed.

Since the pressure receiving portion 52a has the substantially U-shaped cross section, the pressure receiving portion 52a and the pressing portion 60 surround the conductor portion 90a. Therefore, the conductor portion 90a is less likely to fall off, and the clamping of the conductor portion 90a by the pressure receiving portion 52a and the pressing portion 60 is easily maintained.

The connector connecting portion 53 connects the terminal receiving portion 51 and the cable receiving portion 52.

The connector 50, that is, the terminal receiving portion 51, the cable receiving portion 52, and the connector connecting portion 53 are integrally formed of metal.

(Description of Pressing Portion 60)

Next, details of the pressing portion 60 will be described.

Two pressing portions 60 are provided for the anode and the cathode.

The pressing portion 60 is a columnar object whose cross section viewed from the y-direction is a substantially T-shaped in which an intersection portion of said T-shape is located on an upper side or lower side in the z-direction.

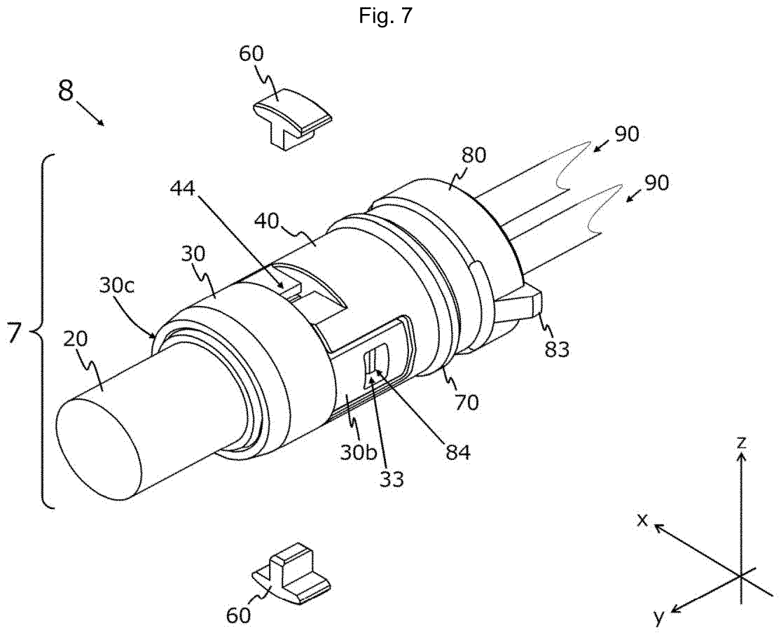

As illustrated in FIG. 7, one pressing portion 60 is fitted into one pressing portion through-hole 44 from the upper side in the z-direction.

The other pressing portion 60 is fitted into the other pressing portion through-hole 44 from a lower side in the z-direction.

By fitting the pressing portion 60 into the pressing portion through-hole 44, the pressing portion 60 presses the conductor portion 90a from a direction different from the direction in which the cover 10 is attached. As a result, the conductor portion 90a between the pressing portion 60 and the pressure receiving portion 52a is crushed, and the conductor portion 90a comes into contact with the pressure receiving portion 52a.

In particular, when the first hooking portion 83 of the bracket 80 is hooked to the first hooking hole 13 of the cover 10, the inner wall of the cover 10 pushes the pressing portion 60 in a direction approaching the pressure receiving portion 52a. Therefore, the contact between the pressure receiving portion 52a and the conductor portion 90a becomes stronger.

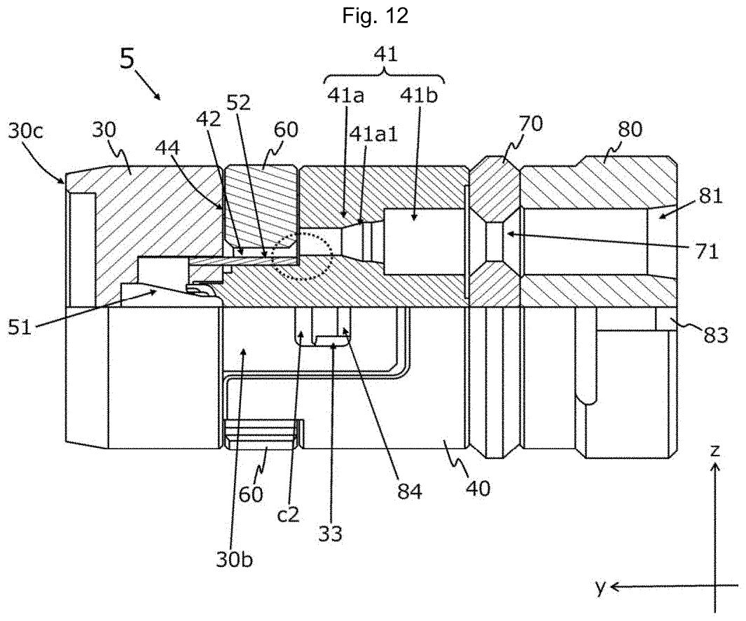

It is desirable that a stepped portion in the z-direction be formed between a contact surface of the pressure receiving portion 52a where the conductor portion 90a is in contact with the pressure receiving portion 52a and a contact surface of the cable through-socket-hole 41 on the front side in the y-direction (conductor-portion holding region 41a) where the conductor portion 90a is in contact with the cable through-socket-hole 41 (see dotted circle region in FIG. 12). Said stepped portion in the z-direction is a step in which the contact surface of the pressure receiving portion 52a becomes closer to a central axis of the second socket 40 than the contact surface of the cable through-socket-hole 41.

Due to this stepped portion, the conductor portion 90a can be bent into an S-shape or a crank shape at a time of pressing. Therefore, a connection state between the pressure receiving portion 52a and the conductor portion 90a can be further strengthened as compared with a form in which bending is not performed.

Dimensions of each portion are determined such that, when the first hooking portion 83 is hooked to the first hooking hole 13 and the pressing portion 60 is pushed into a direction approaching the pressure receiving portion 52a by the cover 10, a cross-sectional area of a space surrounded by the pressing portion 60 and the pressure receiving portion 52a viewed from the y-direction is substantially a same as a cross-sectional area of the crushed conductor portion 90a viewed from the y-direction.

It is desirable that at least one of the pressing portion through-hole 44 and the pressing portion 60 has a structure in which the pressing portion 60 does not come off from the pressing portion through-hole 44 (or a structure in which the pressing portion 60 hardly comes off) even when the pressing into the pressure receiving portion 52a is released, after the pressing portion 60 has been pressed into the pressing portion through-hole 44.

For example, as the structure, it is conceivable that at least one of the pressing portion through-hole 44 and the pressing portion 60 has a protrusion or the like that makes the pressing portion through-hole 44 hold the pressing portion 60 when the pressing by the pressing portion 60 is released.

As a result, it is possible to reduce a possibility that the pressing portion 60 is detached from the pressing portion through-hole 44 and lost when the pressing of the pressing portion 60 against the pressure receiving portion 52a is released.

(Description of gasket 70)

Next, details of the gasket 70 will be described.

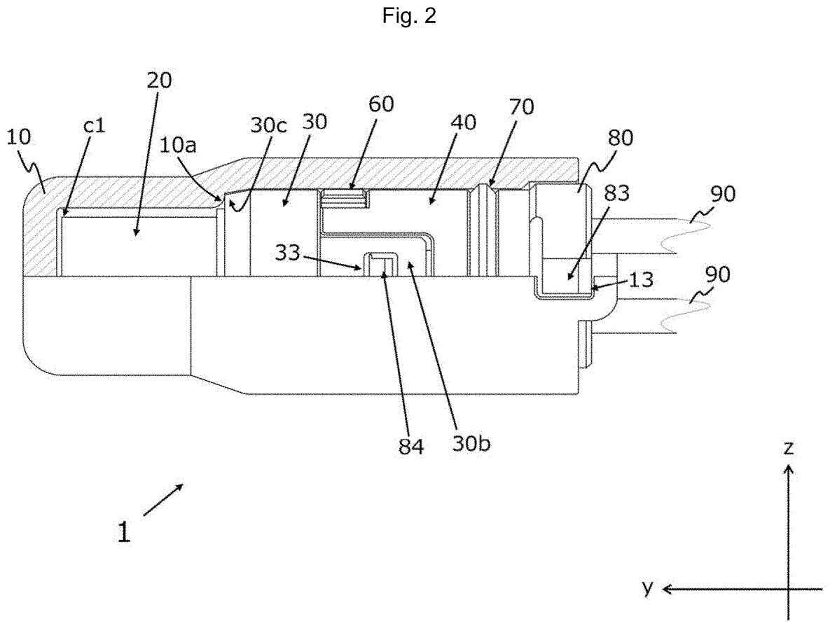

The gasket 70 is an elastic body such as rubber having a substantially cylindrical shape. The gasket 70 is disposed between the second socket 40 and the bracket 80 (see FIGS. 1 and 2).

An outer shape of a region of the gasket 70 in contact with the inner wall of the cover 10 is substantially a same as an inner shape of a contact region of the cover 10 with the gasket 70.

Specifically, the gasket 70 has a diameter of substantially a same dimension as an inner diameter of the contact region of the cover 10 with the gasket 70.

The socket 2 and the gasket 70 are sandwiched between the holding portion 10a of the cover 10 and the bracket 80. When the gasket 70 is pressed in the y-direction, a diameter of the gasket 70 increases.

Therefore, as long as the diameter of the gasket 70 expands to be larger than the inner diameter of the contact region of the cover 10 with the gasket 70 when the gasket 70 is pressed in the y-direction, the diameter of the gasket 70 before being pressed may be smaller than the inner diameter of the contact region of the cover 10 with the gasket 70.

The gasket 70 has cable through-gasket-holes 71 and claw through-gasket-holes 75 (see FIGS. 11 to 13, 15, 18, and 20).

Two cable through-gasket-holes 71 are provided for the anode and the cathode.

The cable through-gasket-hole 71 penetrates a main body of the substantially cylindrical gasket 70 in the y-direction. The cable through-gasket-hole 71 is a hole for inserting the cable 90.

In the cable through-gasket-hole 71, the covering portion 90b of the cable 90 is disposed.

A front side in the y-direction and a rear side in the y-direction of the cable through-gasket-hole 71 have substantially a same diameter as an outer diameter of a protective portion 91b.

A center of the cable through-gasket-hole 71 in the y-direction has a diameter smaller than the outer diameter of the covering portion 90b.

The socket 2 and the gasket 70 are sandwiched between the holding portion 10a of the cover 10 and the bracket 80. When the gasket 70 is pressed in the y-direction, a diameter of the cable through-gasket-hole 71 decreases.

Therefore, as long as the diameter of the cable through-gasket-hole 71 is reduced to be smaller than the diameter of the covering portion 90b when the gasket 70 is pressed in the y-direction, the diameter of the cable through-gasket-hole 71 before being pressed may be larger than the diameter of the covering portion 90b.

The two cable through-gasket-holes 71 are arranged side by side in the z-direction.

One cable through-gasket-hole 71, one cable through-socket-hole 41, and one cable through-bracket-hole 81 are arranged side by side in the y-direction.

Similarly, the other cable through-gasket-hole 71, the other cable through-socket-hole 41, and the other cable through-bracket-hole 81 are arranged side by side in the y-direction.

Two claw through-gasket-holes 75 are provided.

The claw through-gasket-hole 75 penetrates the main body of the substantially cylindrical gasket 70 in the y-direction. The claw through-gasket-hole 75 is a hole for inserting the second hooking portion 84.

The claw through-gasket-hole 75 has substantially a same shape and size as a cross section of a region where a foot portion 84a of the second hooking portion 84 is in contact with the claw through-gasket-hole 75 as viewed from the y-direction.

The socket 2 and the gasket 70 are sandwiched between the holding portion 10a of the cover 10 and the bracket 80. When the gasket 70 is pressed in the y-direction, the holes of the claw through-gasket-holes 75 are reduced.

The two claw through-gasket-holes 75 are arranged side by side in the x-direction.

One of the claw through-gasket-holes 75, one of the claw through-socket-holes 45, and the foot portion 84a of one of the second hooking portions 84 are arranged side by side in the y-direction.

The other claw through-gasket-hole 75, the other claw through-socket-hole 45, and the foot portion 84a of the other second hooking portion 84 are arranged side by side in the y-direction.

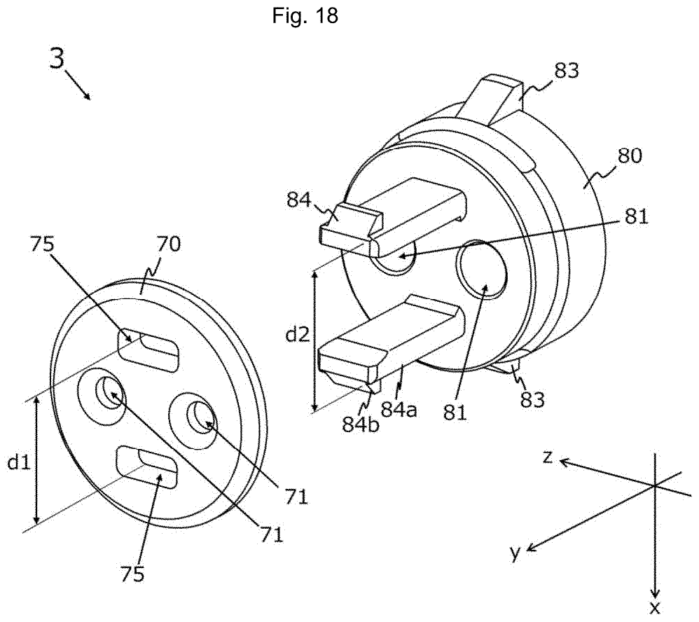

The two claw through-gasket-holes 75 are arranged such that a distance (first distance d1) between outer ends in the x-direction of the two claw through-gasket-holes 75 is shorter than a distance (second distance d2) between outer ends in the x-direction of the foot portions 84a of the two second hooking portions 84 to be described later (see FIG. 18).

As a result, when the second hooking portion 84 is passed through the claw through-gasket-hole 75, the outer end in the x-direction of the claw through-gasket-hole 75 comes into close contact with the foot portion 84a, so that the gasket 70 is hardly detached from the bracket 80.

(Description of Bracket 80)

Next, details of the bracket 80 will be described.

The bracket 80 covers and clamps the light emitting element 20, the first socket 30, the second socket 40, and the gasket 70 together with the cover 10.

As illustrated in FIGS. 1 to 5, 7 to 15, and 18, the bracket 80 includes the cable through-bracket-holes 81, the first hooking portions 83, and the second hooking portions 84. The bracket 80 has a substantially cylindrical shape.

Two cable through-bracket-holes 81 are provided for the anode and the cathode.

The cable through-bracket-hole 81 penetrates the main body of the substantially cylindrical bracket 80 in the y-direction. The cable through-bracket-hole 81 is a hole for inserting the cable 90.

In the cable through-bracket-hole 81, the covering portions 90b of the cable 90 is disposed.

The two cable through-bracket-holes 81 are arranged side by side in the z-direction.

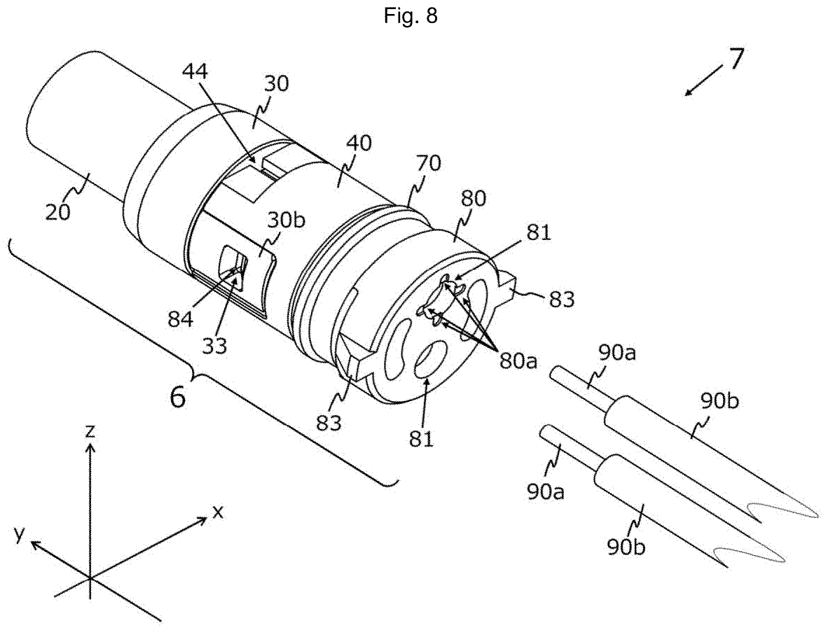

The rear side of the bracket 80 in the y-direction desirably has a third mark 80a so as not to mistake between an insertion of one cable 90 into one cable through-bracket-hole 81 and an insertion of the other cable 90 into the other cable through-bracket-hole 81 (see FIG. 8).

The present embodiment shows an example in which four grain-shaped third marks 80a are provided around one of the cable through-bracket-holes 81 on the rear side of the bracket 80 in the y-direction.

However, the third mark 80a is not limited to the mark illustrated in FIG. 8, and may be a mark having another shape.

Two first hooking portions 83 are provided.

The first hooking portions 83 has a protrusion or a hook-shaped object. The protrusion or the hook-shaped object of the first hooking portion 83 extends outward in the x-direction from the main body of the substantially cylindrical bracket 80 and is used to be hooked to the first hooking hole 13 of the cover 10.

The two first hooking portions 83 are arranged side by side in the x-direction.

Two second hooking portions 84 are provided.

The second hooking portion 84 has the foot portion 84a and a tip portion 84b.

The foot portion 84a extends to a front side in the y-direction from the main body of the substantially cylindrical bracket 80.

The tip portion 84b has a protrusion or a hook-shaped object to be hooked to the second hooking hole 33 of the first socket 30.

The two second hooking portions 84 are arranged side by side in the x-direction.

Dimensions of the second hooking portion 84 and the like are determined such that there is formed a gap (second clearance c2) in the y-direction between the tip portion 84b of the second hooking portion 84 and the second socket 40, in a state where the electrical member 1 is assembled, that is, in a state where the gasket 70 is pressed in the y-direction (see FIG. 13).

In a state where the first assembly 5 is assembled, that is, in a state where the gasket 70 is not pressed in the y-direction, the second clearance c2 has a length larger than an amount by which the gasket 70 contracts in the y-direction.

(Description of Cable 90)

Next, the cable 90 will be described in detail.

Two cables 90 are provided for the anode and the cathode.

One cable 90 is used to be electrically connected to the one terminal 21 (anode), and the other cable 90 is used to be electrically connected to the other terminal 21 (cathode).

The cable 90 includes the conductor portion 90a and the covering portion 90b. The covering portion 90b is made of an insulating material and covers a periphery of the conductor portion 90a.

However, a portion inserted into the connector 50 and a portion disposed on the front side in the y-direction of the cable through-socket-hole 41 (conductor-portion holding region 41a) are not covered with the covering portion 90b, and the conductor portion 90a is exposed.

Power is supplied from an external power supply to the light emitting element 20 via the cable 90 and the connector 50.

(Assembly Procedure of Electrical Member 1)

Next, an assembly procedure of the electrical member 1 will be described with reference to FIG. 1 and the like.

The second hooking portion 84 is passed through the claw through-gasket-hole 75, and the gasket 70 is attached to the bracket 80 (gasket attaching step, see FIG. 18).

This brings the bracket assembly 3 into a completed state.

In a state where the two connectors 50 are sandwiched, the first socket 30 is attached to the second socket 40, and the socket 2 is formed (socket assembling step, see FIGS. 16 and 17).

Specifically, the terminal receiving portion 51 of the connector 50 is fitted into the first connector storage hole 32, and then the first socket 30 is attached to the second socket 40.

Alternatively, the cable receiving portion 52 of the connector 50 may be fitted into the second connector storage hole 42, and then the first socket 30 may be attached to the second socket 40.

Thus, the first socket 30 and the second socket 40 hold the connector 50.

Further, the socket 2 is in a completed state.

The second hooking portion 84 is passed through the claw through-socket-hole 45, the tip portion 84b of the second hooking portion 84 is hooked to the second hooking hole 33, and the second socket 40 and the gasket 70 are sandwiched. In this state, the first socket 30 is attached to the bracket 80 (socket attaching step, see FIG. 15).

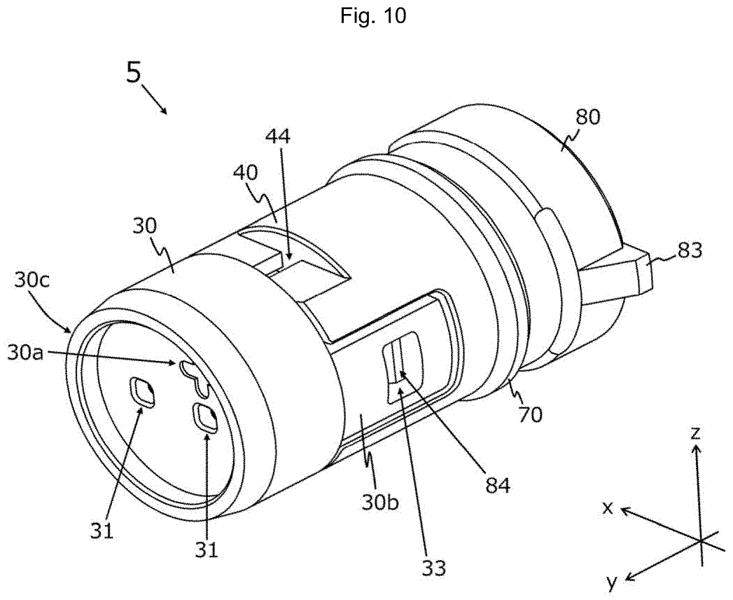

As a result, the first assembly 5 is in a completed state (see FIGS. 10 to 14).

At this point, the gasket 70 is hardly deformed.

The terminal 21 is inserted into the terminal hole 31, and the light emitting element 20 is attached to the first socket 30 (light emitting element attaching step, see FIG. 9).

When the terminal 21 is inserted into the terminal hole 31, the tip of the terminal 21 passes through the terminal insertion hole 50d of the connector 50 and is clamped between the leaf spring portion 51b and the edge 51c of the terminal receiving portion 51 of the connector 50.

As a result, the terminal 21 is hardly detached from the first socket 30.

That is, by simply inserting the terminal 21 into the terminal hole 31, the light emitting element 20 can be easily attached to the first socket 30 by biasing forces of the leaf spring.

As a result, the second assembly 6 is in a completed state.

The cable 90 is inserted into the cable through-bracket-hole 81, the cable through-gasket-hole 71, and the cable through-socket-hole 41 (cable insertion step, see FIG. 8).

The cable 90 is inserted into the cable through-bracket-hole 81 or the like such that the tip of the conductor portion 90a overlaps the cable receiving portion 52 in the z-direction.

The cable receiving portion 52 can be visually recognized through the pressing portion through-hole 44. Therefore, the tip of the conductor portion 90a is inserted through the pressing portion through-hole 44 so as to be in a positional relationship of overlapping with the cable receiving portion 52 in the z-direction, and it can be confirmed whether or not the cable 90 is correctly inserted (see FIG. 5).

As a result, the third assembly 7 is in a completed state.

The covering portion 90b of the cable 90 is held by a portion having a small diameter at the center in the y-direction of the cable through-gasket-hole 71.

As a result, the cable 90 is hardly detached from the bracket 80.

The pressing portion 60 is inserted into the pressing portion through-hole 44, and the tip of the conductor portion 90a is brought close to the pressure receiving portion 52a of the cable receiving portion 52 by the pressing portion 60 (pressing step, see FIG. 7).

As a result, the cable 90 is less likely to come off from the bracket 80.

Thus, the fourth assembly 8 is in a completed state.

The fourth assembly 8 is inserted into the cover 10, and the first hooking portion 83 is hooked to the first hooking hole 13 (cover attaching step, see FIG. 3).

As a result, the electrical member 1 is in a completed state (see FIGS. 1 and 2).

When the first hooking portion 83 is hooked to the first hooking hole 13, the holding portion 10a of the cover 10 and the bracket 80 sandwich the first socket 30, the second socket 40, and the gasket 70 in the y-direction.

As a result, the gasket 70 is pressed in the y-direction and is deformed. That is, the gasket 70 is pressed in the direction in which the cover 10 is attached, the diameter of the gasket 70 increases, and the diameter of the cable through-gasket-hole 71 decreases.

In addition, the cover 10 pushes the pressing portion 60 in the z-direction so that the pressing portion 60 approaches the pressure receiving portion 52a.

By increasing the diameter of the gasket 70, the gasket 70 and the cover 10 are brought into close contact with each other.

By reducing the diameter of the cable through-gasket-hole 71, the gasket 70 and the covering portions 90b of the cables 90 are brought into close contact with each other.

By the close contact between the gasket 70 and the cover 10 and by the close contact between the gasket 70 and the covering portions 90b, the space surrounded by the cover 10 and the gasket 70 is sealed.

By the close contact between the gasket 70 and the covering portion 90b, the holding state of the cable 90 can further strengthen.

When the cover 10 pushes the pressing portion 60 in the z-direction, the conductor portion 90a is crushed between the pressing portion 60 and the pressure receiving portion 52a, and the connection state between the conductor portion 90a and the pressure receiving portion 52a is strengthened.

Further, the conductor portion 90a is bent into an S-shape or a crank-shape by the stepped portion between the contact surface of the pressure receiving portion 52a and the contact surface on the front side in the y-direction of the cable through-socket-hole 41 (conductor-portion holding region 41a).

The connection state between the conductor portion 90a and the pressure receiving portion 52a can be further strengthened by the S-shaped or crank-shaped bending.

By the deformation of the gasket 70, it is possible to realize waterproofing of the space surrounded by the cover 10 and the gasket 70 and holding of the cables 90. In addition, as compared with a form in which waterproofing or cable holding is performed using a plurality of O-rings or sealants, the structure can be simplified, attachment and detachment can be facilitated, and workability can be improved.

In addition, at a time of hooking of the cover 10 and the bracket 80 which deform the gasket 70, a cable connection using the pressing portions 60 can be simultaneously performed.

(Disassembly Procedure of Electrical Member 1)

Next, a disassembly procedure of the electrical member 1 will be described with reference to FIG. 1 and the like.

The cover 10 is removed from the electrical member 1.

Specifically, the hooking state is released by, for example, spreading the portion of the cover 10 where the first hooking hole 13 is present, outward in the x-direction, and the first hooking portion 83 is removed from the first hooking hole 13.

As a result, the cover 10 and the fourth assembly 8 are separated (cover removal step, see FIGS. 1 to 3).

Next, the pressing portion 60 is removed from the fourth assembly 8.

Specifically, the pressing portion 60 is pulled out in the z-direction, and the pressing by the pressing portion 60 is released (press releasing step, see FIG. 7).

As a result, the state in which the conductor portion 90a is clamped between the pressing portion 60 and the pressure receiving portion 52a is released.

As a result, the pressing portions 60 and the third assembly 7 are separated.

Note that, in a case where the structure in which the pressing portion 60 does not come off from the pressing portion through-hole 44 (or the structure in which the pressing portion 60 hardly comes off) is provided, the pressing portion 60 is held without being separated from the pressing portion through-hole 44.

Next, the cable 90 is removed from the third assembly 7.

Specifically, the cable 90 is pulled out from the cable through-bracket-hole 81 (cable pulling-out step, see FIG. 8).

The conductor portion 90a has been bent into the S-shape or the crank-shape by pressing by the pressing portions 60, but said pressing is released. Therefore, the cable 90 can be detached from the third assembly 7 without breaking the cables 90.

As a result, the cable 90 and the second assembly 6 are separated.

Next, the light emitting element 20 is removed from the second assembly 6.

Specifically, terminal 21 is pulled out from terminal hole 31, so that the light emitting element 20 is removed from first socket 30 (light emitting element removal step, see FIG. 9).

The terminal 21 is clamped by the terminal receiving portion 51. However, it can be removed by pulling out with a force exceeding the biasing force of leaf spring portion 51b.

As a result, the light emitting element 20 and the first assembly 5 are separated.

Next, the bracket assembly 3 is removed from the first assembly 5.

Specifically, the hooked state is released by pushing tip in the y-direction of the second hooking portion 84 inward in the x-direction through the second hooking hole 33, and the second hooking portion 84 is removed from the second hooking hole 33. As a result, the socket 2 and the bracket assembly 3 are separated (socket removal step, see FIG. 15).

The first socket 30 is removed from the second socket 40 (socket disassembly step, see FIGS. 16 and 17). Thereafter, the connector 50 held by the first socket 30 or the second socket 40 is removed.

The gasket 70 is removed from the bracket 80 (gasket removal step, see FIG. 18).

Accordingly, disassembly of the members constituting the electrical member 1 is completed.

### OTHER EMBODIMENTS

In the present embodiment, an example has been described in which an electronic component attached to the first socket 30 is the light emitting element 20. However, the electronic component attached to the first socket 30 may be another electronic component that operates by supplying power via the cable 90.

In the present embodiment, an example in which the connector 50 is held by two members (the first socket 30 and the second socket 40) has been described. However, the connector 50 may be held by one member or by three or more members.

Further, in the present embodiment, an example has been described in which the claws for hooking (the first hooking portion 83 and the second hooking portion 84) are all provided on the bracket 80. However, the first hooking portions 83 may be provided on the cover 10, or the second hooking portions 84 may be provided on the first socket 30.

In this case, the first hooking hole 13 and the second hooking hole 33 are provided in the bracket 80.

The attachment of the cover 10 to the bracket 80 is not limited to the hooking using the first hooking hole 13 and the first hooking portion 83, and may be performed by other fixing methods.

The attachment of the first socket 30 and the bracket 80 is not limited to the hooking using the second hooking hole 33 and the second hooking portion 84, and may be performed by other fixing methods.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. These embodiments and modifications thereof are included in the scope and gist of the invention and are included in the invention described in the claims and the equivalent scope thereof.

### REFERENCE SIGNS LIST

1 Electrical member
2 Socket (first socket, second socket, and connector)
3 Bracket assembly (gasket and bracket)
5 First assembly (socket and bracket assembly)
6 Second assembly (first assembly and light emitting element)
7 Third assembly (second assembly and cable)
8 Fourth assembly (third assembly and pressing portion)
10 Cover
10a Holding portion
13 First hooking hole
20 Light emitting element
21 Terminal
30 First socket
30a First mark
30b Mounting piece
30c Peripheral edge portion
31 Terminal hole
32 First connector storage hole
33 Second hooking hole
36 Fitting recess
40 Second socket
40a Second mark
41 Cable through-socket-hole
41a Conductor-portion holding region
41a1 Inclined region
41b Covering-portion holding region
42 Second connector storage hole
44 Pressing portion through-hole
45 Claw through-socket-hole
46 Fitting protrusion
50 Connector
51 Terminal receiving portion
51a Terminal insertion portion
51b Leaf spring portion
51c Edge
51d Terminal insertion hole
52 Cable receiving portion
52a Pressure receiving portion
53 Connector connecting portion
60 Pressing portion
70 Gasket
71 Cable through-gasket-hole
75 Claw through-gasket-hole
80 Bracket
80a Third mark
81 Cable through-bracket-hole
83 First hooking portion (for mounting cover)
84 Second hooking portion (for mounting socket)
84a Foot portion
84b Tip portion
90 Cable
90a Conductor portion
90b Covering portion
c1 First clearance
c2 Second clearance
d1 First distance
d2 Second distance

1. A sealing mechanism inside an electrical member, comprising:
a gasket having a cable through-gasket-hole through which a cable passes, and being made of an elastic body;
a socket of an electronic component that operates by supplying power via the cable;
a cover that covers the electronic component, the socket, and the gasket; and
a bracket that sandwiches the electronic component, the socket, and the gasket together with the cover, wherein
the gasket is disposed between the socket and the bracket, and
by attaching the cover to the bracket, the gasket is pressed in a direction in which the cover is attached, and is deformed.

2. The sealing mechanism inside the electrical member according to claim 1, wherein the gasket is pressed in the attaching direction, a diameter of the gasket increases, and a diameter of the cable through-gasket-hole decreases.

3. The sealing mechanism inside the electrical member according to claim 1, wherein by attaching the cover to the bracket, the gasket is in close contact with an inner wall of the cover, the cable through-gasket-hole is in close contact with a covering portion of the cable, and a space between the cover and the gasket is sealed.

4. The sealing mechanism inside the electrical member according to claim 1, further comprising a pressing portion, wherein
the socket includes a connector,
the connector includes a leaf spring portion that clamps a terminal of the electronic component, and a pressure receiving portion that contacts with a conductor portion of the cable,
the pressing portion presses the conductor portion in a direction in which the pressure receiving portion is located, and
pressing by the pressing portion is performed by attaching the cover to the bracket.

5. The sealing mechanism inside an electrical member according to claim 4, wherein
the pressing portion presses the conductor portion from a direction different from the direction in which the cover is attached, and
pressing is performed by the pressing portion, and the conductor portion is crushed between the pressing portion and the pressure receiving portion.

6. The sealing mechanism inside the electrical member according to claim 4, wherein the socket includes a pressing portion through-hole into which the pressing portion is inserted.

7. The sealing mechanism inside the electrical member according to claim 6, wherein the pressing portion through-hole holds the pressing portion when the pressing by the pressing portion is released.

8. The sealing mechanism inside the electrical member according to claim 4, wherein
the socket includes a cable through-socket-hole through which the cable passes, and
a stepped portion is formed between a contact surface of the pressure receiving portion with which the conductor portion is in contact and a contact surface of the cable through-socket-hole with which the conductor portion is in contact.

9. The sealing mechanism inside the electrical member according to claim 1, wherein the cover is attached to the bracket by hooking.

10. The sealing mechanism inside the electrical member according to claim 1, wherein the socket includes a first socket in contact with the electronic component and a second socket in contact with the gasket.

11. The sealing mechanism inside the electrical member according to claim 10, wherein
one of the cover and the bracket includes a first hooking portion,
the cover is attached to the bracket by the first hooking portion in a state where the first socket, the second socket, and the gasket are sandwiched by the cover and the bracket,
one of the first socket and the bracket includes a second hooking portion, and
the first socket is attached to the bracket by the second hooking portion in a state where the second socket and the gasket are sandwiched between the cover and the bracket.

12. The sealing mechanism inside the electrical member according to claim 1, wherein
the socket has a cable through-socket-hole through which the cable passes, and
the cable through-socket-hole has an inclined region whose inner diameter decreases from a side where the cable is inserted.
